(19) United States
(12) Patent Application Publication
(10) Pub. No.: US 2016/0061179 A1
(43) Pub. Date: Mar. 3, 2016

(54) Omni directional wave energy apparatus and method

(71) Applicant: ATLANTIC - P. PECHLIVANIDES, IKE, Athens (GR)

(72) Inventor: Pantelis Pechlivanides, Athens (GR)

(21) Appl. No.: 14/785,340

(22) PCT Filed: Jun. 6, 2014
(86) PCT No.: PCT/GR2014/000035

§ 371 Date: Oct. 18, 2015

(30) Foreign Application Priority Data
Jun. 20, 2013 (GR) 20130100361

(51) Int. Cl. F03B 13/18

(52) U.S. Cl. CPC F03B 13/1805; F03B 13/182

(57) ABSTRACT

A wave energy converter (1) consisting of a pole (2) with a wave catching structure (9) connected to a base (7) through a ball or universal joint (6). The pole oscillates as the waves hit the different sides of the wave catching structure. The pole is biased towards the vertical position. The motion of the pole activates devices for absorption and extraction of energy such as piston cylinders (3) with one end attached to the pole and the other to the base (7) by ball or universal joints (4) and (5), which also restrict the motion of the pole along specific meridians by use of appropriate hydraulic components. The possibility of motion of the wave catching structure along the pole increases the absorption of wave energy. Being able to exploit waves from any direction and also to assume a floating form, it is suitable for both deep and shallow waters.

### RELATED ART

Many devices have been proposed for extraction of energy from waves or in short referred to as WEC,s (Wave Energy Converters). Some of them concentrate on absorbing the potential energy of waves, others on the kinetic energy and still others exploit both.

Among the devices that exploit the kinetic energy are the pitching wave energy converters. These devices are usually attached from one side to the bottom or to some other fixed structure through one or more pivots, while the other side is free to oscillate. They are usually placed near the shore at depths from 8 m to 25 m to take advantage of the fact that most of the energy of the waves becomes kinetic and the surge phenomenon due to the inclination of the bottom. The oscillation of the device is converted to fluid oscillation by the use of piston cylinders and subsequently energy is extracted by standard methods. There are two types of such devices: The flap devices and the pole devices.

Flap devices are presented in U.S. Pat. No. 4,580,400 with the flap hanging down and using a reflective cavity, in U.S. Pat. No. 4,371,788, which is hinged to the bottom of the sea and using a reflector, in U.S. Pat. No. 6,184,590 using a flap hinged at the bottom that is mechanically connected by rods to a motor. In WO03/036081 the device uses a flap, which is entirely submerged and hinged at the bottom. US Application Publication 2004/0007881 A1 presents an entirely submerged flap that is hinged to the bottom. U.S. Pat. No. 7,834,474 presents a device that uses a flap hinged at the bottom and crossing the sea surface at its upward position. This device uses double action piston cylinders to pump fluid that is used for power production.

A pole device was first presented by S. H. Salter (see “The swinging Mace” In: Proceedings of Workshop Wave Energy R&D. Cork, Ireland 1992, European Commission Rep EU 15079 EN pp 197-206. Or see “Wave Energy Utilization: A review of the Technologies” by A. F. de Falcao, in “Renewable and Sustainable Energy Reviews” 14 (2010) pp 899-918). In that presentation a winch-drum is attached to the top of the pole. Around the drum a cable is wound several times. The ends of the cable are anchored at the sea bottom. The motion of the pole makes the winch turn and produce energy.

Another pole device is EB Frond. This device is hinged on a base placed at the bottom. The other side of the pole carries a wide fin. Hydraulic pistons cylinders absorb the energy from the relative motion between the pole and the base. The WRASPA device of the University of Lancaster is also a pole device (see “An Investigation into Power from Pitch-Surge Point Absorber WEC” by R. V. Chaplin and A. G. Aggidis, IEEE 2007). This is similar to EB Frond but it differs in the fin shape.

Finally one more pole device, whose fin resembles a triple head, is described in WO2011026173A1. A similar device is exposed in US patent application 2010/0156106.

All these devices (flap and pole) are restricted to oscillate in one direction only. However, the direction of waves, even near the shore, is known to vary by at least 90° degrees. The inability of these devices to re-orient, results in substantial loss of power. To reorient a flap device is impossible since it is hinged to the bottom in at least two points. It is possible, though, to reorient a pole device by changing the hinge at the bottom into a universal joint. However, problems arise as one needs more piston cylinders to support the pole and absorb energy from different directions. First, the motion of the pole will be undisciplined and suboptimal describing any path or in the worst case piston cylinders will oppose each other blocking the motion of the pole. Second, the pressures and flows coming from the different piston cylinders will be random rendering them useless or highly inefficient. Further, the fins on the top of the pole have to be replaced by a suitable wave catching structure to catch waves from all directions.

In this invention we present an omni directional pole wave energy converter that, uses physical laws to restrict the motion of the pole to power efficient paths (meridians) and simultaneously produces and exploits disciplined fluid flows and pressures from the cylinder pistons. Instead of a fin an appropriate structure is placed at the oscillating end of the pole to catch waves from all directions. A variation of the device allowing the wave catching structure to move along the pole, enables the devices to exploit the potential energy of the waves as well, thus increasing its efficiency.

Such a device is useful not only for producing energy at locations near the shore by taking advantage of the kinetic (and surge) motion of the waves, but also for deep sea, where it can be floating and appropriately moored.

### SUMMARY OF THE INVENTION

The present invention discloses a wave energy conversion (WEC) device comprising a pole that has a wave catching structure near one end of the pole, while the other end is attached to a base with a ball joint or a universal joint. The base is fixed to the bottom or to a bearing structure. The pole is placed with the oscillating end upwards but there are embodiments with the pole hanging down. The pole is biased towards the vertical position. This is achieved by gravity in the case the pole is hanging down. In case it is pointing upwards, buoyancy may be provided by the wave catching structure at the upper part of the pole, which must have the appropriate empty, floodable and de-floodable compartments. The buoyancy and weight of the pole and wave catching structure must be adjusted so that there is a synchronism between the self frequency of the device and the frequency of the waves.

The device also consists of a power absorption assembly that absorbs power from the relative motion of the pole with respect to the base. The power absorption assembly may include double action piston cylinders. One side of each cylinder is attached to the pole by a ball joint or universal joint, and the other side is attached to the base through a ball joint or a universal joint. The motion of the pole causes the fluid in the piston cylinder to be pressed and oscillate through the ports of the cylinder.

The device also comprises one or more systems that (a) restrict the allowed paths that the pole may follow, to optimize energy absorption from the waves, and (b) regulate flow to optimize energy extraction. Such systems may consist of assemblies of conduits, check valves, manifold boxes, valves, sensors and other hydraulic components and/or computers to regulate the flow of fluid from the ports of the piston cylinders through conduits to one or more energy extracting assemblies. Such energy extracting assemblies may include accumulators, hydraulic motors that in turn move generators, or water turbines such as pelton wheels that turn generators etc.

The wave catching structure may take several embodiments like: (a) cylinder, (b) inverted frustum cone, (c) inverted frustum of pyramid, (d) any shape resulting from the revolution of a curve around the pole axis, (e) a system of fins parallel to the pole axis (3,4 or more fins), (f) a rigid cage containing one or more flexible containers filled or partly filled with fluid (air, water etc.).

The device further allows the possibility for the wave catching structure to slide along the pole. This oscillation according to the wave motion can further exploit the wave energy (potential and kinetic) by the use of power absorption components, like piston cylinders.

The device can be placed at the sea bottom or on a fixed structure or it can float. In the latter case a long leg is placed beyond the base extending downward, in the opposite to the pole direction. This leg must carry means (like vertical and horizontal fins) to resist motion horizontally and vertically. The whole device is appropriately moored.

In extreme weather conditions the device can be protected by releasing the pressure of the piston cylinders and letting the pole flex freely on the universal joint to ease stresses. Also the buoyancy maybe lowered by flooding water in empty compartments of the wave catching structure. If in floating embodiment, the flooding of the wave catching structure and/or the base and/or the lower part of the leg will cause the device to sink deeper to avoid harsh conditions near the surface.

Deployment and maintenance can be facilitated by de-flooding the base (or/and lower placed compartments if in floating form), and the wave catching structure and filling them with air. The device is then floating horizontally and can be towed to and from a harbor.

The present invention also provides a method to extract energy from waves comprising the steps of:
(a) deploying a device according to this invention
(b) placing the device at the sea bottom or mooring it, if in floating form, as described in the invention
(c) optimizing power absorption of the device and the extracted power

### LIST OF DRAWINGS

FIG. 1 A schematic view of an embodiment of the device

FIG. 2 A view of an embodiment of the device in 3D space

FIG. 3. The geometry and principles for motion of the device with two piston cylinders

FIG. 4a A schematic embodiment of the device with 3 piston cylinders

FIG. 4b The hydraulic circuit of an embodiment with 3 piston cylinders

FIG. 4c Detail of max/min component

FIG. 5 A schematic embodiment of the device with 5 piston cylinders

FIG. 6a A schematic embodiment of the device with 4 piston cylinders

FIG. 6b The hydraulic circuit of an embodiment with 4 piston cylinders

FIG. 6c Detail of optimization assembly

FIG. 7a A schematic embodiment of the device with 6 piston cylinders

FIG. 7b The hydraulic circuit of an embodiment with 6 piston cylinders

FIG. 8a An embodiment of the wave capturing structure

FIG. 8b An embodiment of the wave capturing structure

FIG. 8c An embodiment of the wave capturing structure

FIG. 8d An embodiment of the wave capturing structure

FIG. 9a An embodiment of the wave capturing structure: A rigid cage containing flexible containers in upright position

FIG. 9b An embodiment of the wave capturing structure: A rigid cage containing flexible containers in tilted position.

FIG. 9c An embodiment of the flexible containers within the rigid cage.

FIG. 10 An embodiment fixed at the bottom

FIG. 11 A floating embodiment.

### DETAILED DESCRIPTION

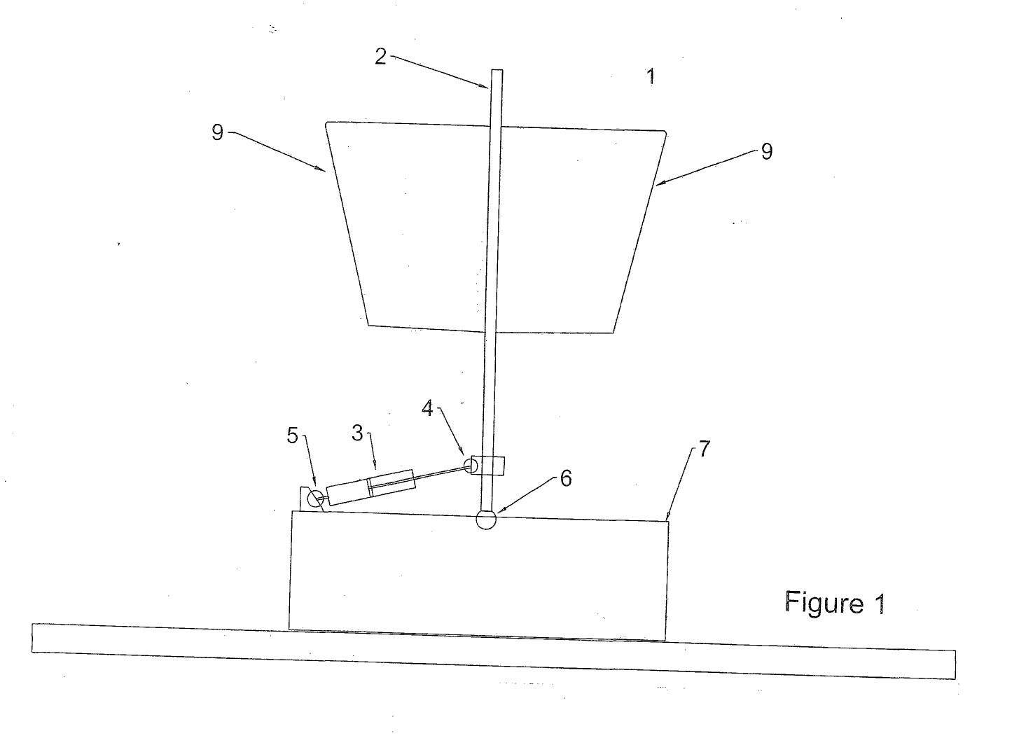

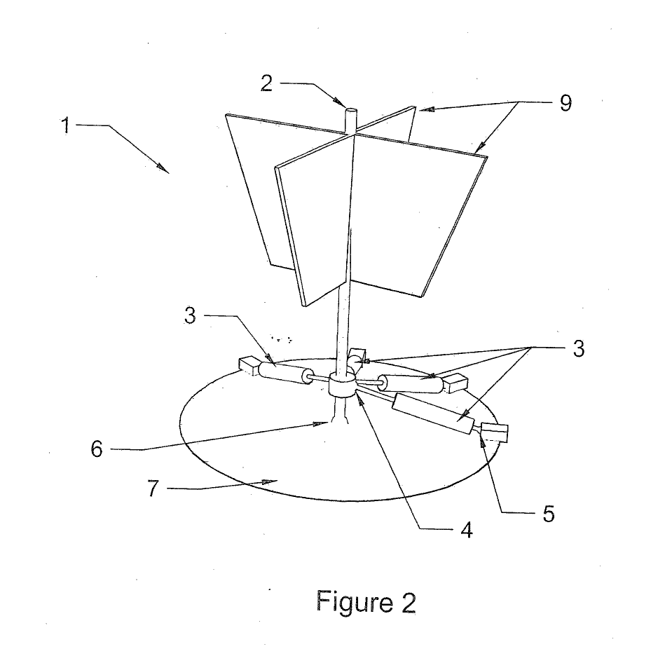

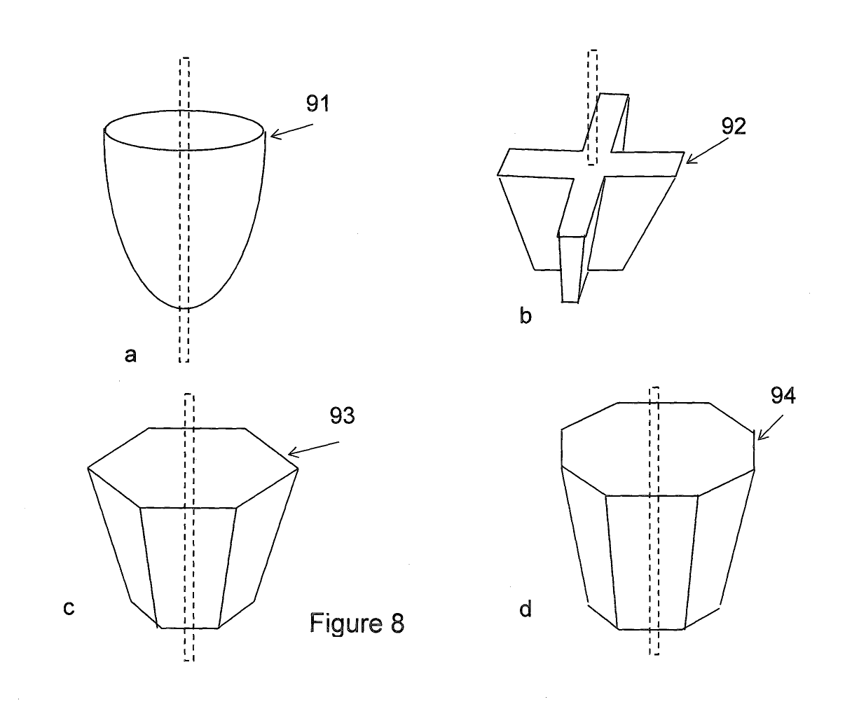

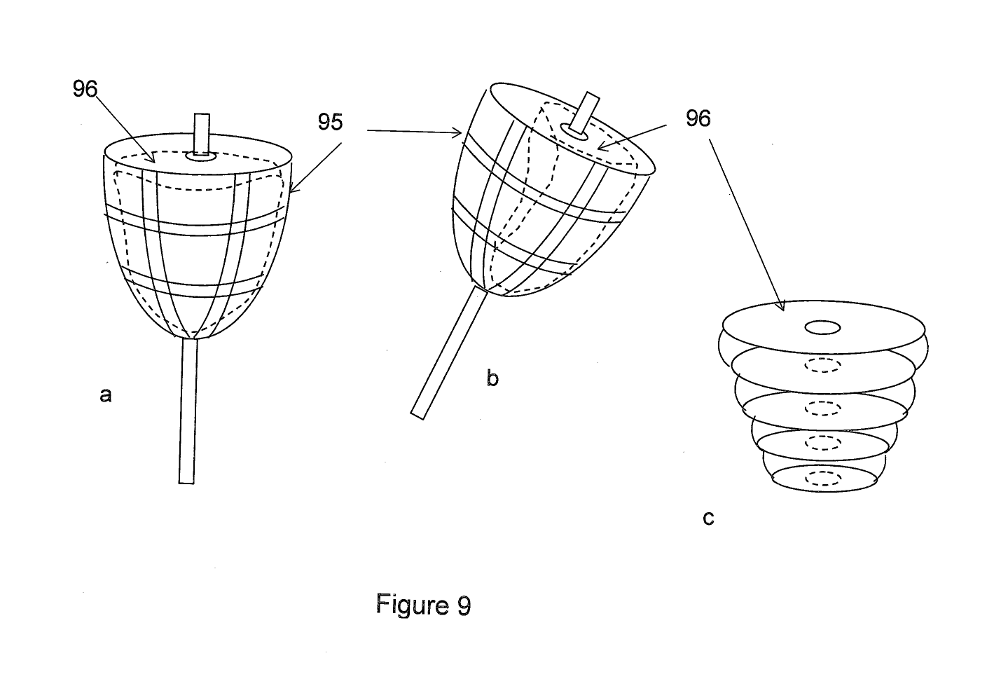

Referring to FIG. 1 and subsequent figures an embodiment of the device is presented as (1). It consists of a pole (2) that is attached to a base (7) with a ball (or double ball) joint or universal (or double universal) joint (6). The pole has on its one side a wave catching structure (9). In the present embodiment of FIGS. 1 and 2, there are four fins at 90° degrees from each other. However, there are other wave catching devices that as we discuss later (see FIGS. 8a, 8b, 8c, 8d, 9a, 9b, 9c). The device also consists of double action piston cylinders (3). One end of each piston cylinder is attached to the pole (2) with a ball joint or universal joint (4) and the other end is attached to the base (7) with a ball joint or universal joint (5). The use of ball or universal joints allows the pole to move freely in all directions. In other words, the tip of the pole can describe any path on the semi sphere defined by the center at (6) and radius defined by the pole. In the embodiment of FIG. 2, four piston cylinders are used. The piston cylinders are radially spaced at 0°, 45°, 90°, 135° degrees angles. Each piston cylinder has two ports. It is possible to have other configurations, as will be explained below, but in all cases one must consider that the motion of the pole in combination with the position of the piston cylinders, along with the use of check valves, influences the motion of the fluid in them, which in turn restricts the allowed paths of motion of the pole.

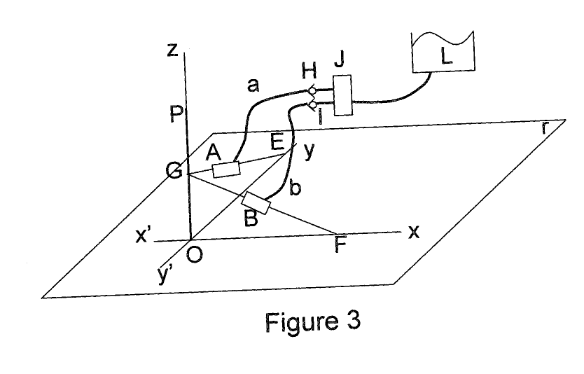

To make this clear, we will first consider a simple geometrical configuration presented in FIG. 3. On a plane r let x′x and y′y represent Cartesian axes intersecting at the origin O. Let OP vertical to the plane r along the z axis. Let G a point on OP and F a point on Ox and E a point on Oy so that OF=OE. Suppose piston cylinder A is placed along GE and piston cylinder B along GF. We will study what happens when the tip of the pole P moves in the first upper hemi-spherical quadrant (whose projection on plane r is xOy). Let conduits a and b start from the lower port of each piston cylinder. Each of these conduits has a check valve H, I respectively and both end on a manifold J. On the outflow side of the manifold a conduit leads to a tank L so that constant pressure is applied. The tank and conduits and piston cylinders are filled with fluid. If we try to move the pole in any direction in the first quadrant the pole will not move unless we exceed the pressure exerted by the liquid in tank L. But even if we do, the pole ill not move, because of the check valves H, I and manifold J, unless the pole moves in one of three meridians: (a) The meridian lying on the plane zOx (0° degrees meridian) (b) The meridian lying on the plane zOy (90° degrees meridian) (c) The meridian at 45° degrees. This is so because, when the pressure in conduit a is greater then the pressure in conduit b the check valve I at conduit b is blocked thus blocking B and making the length GF unchangeable. But the motion, where only the length GE changes, is allowed. This is motion along the 90° meridian. The same argument reversed holds for motion along the 0° degrees meridian. It is also possible to move so that the pressure in both conduits a, b are equal. Then the check valves H, I are both open. This allows motion along the 45° degrees meridian. The restrictions described above do not prohibit the possibility of following piecewise permissible directions like: first a path along the 0° degrees meridian until some point, then move parallel to the 90° degrees meridian up to another point and then parallel to the 0° degrees meridian again then a path keeping the pressure in a and b equal etc.

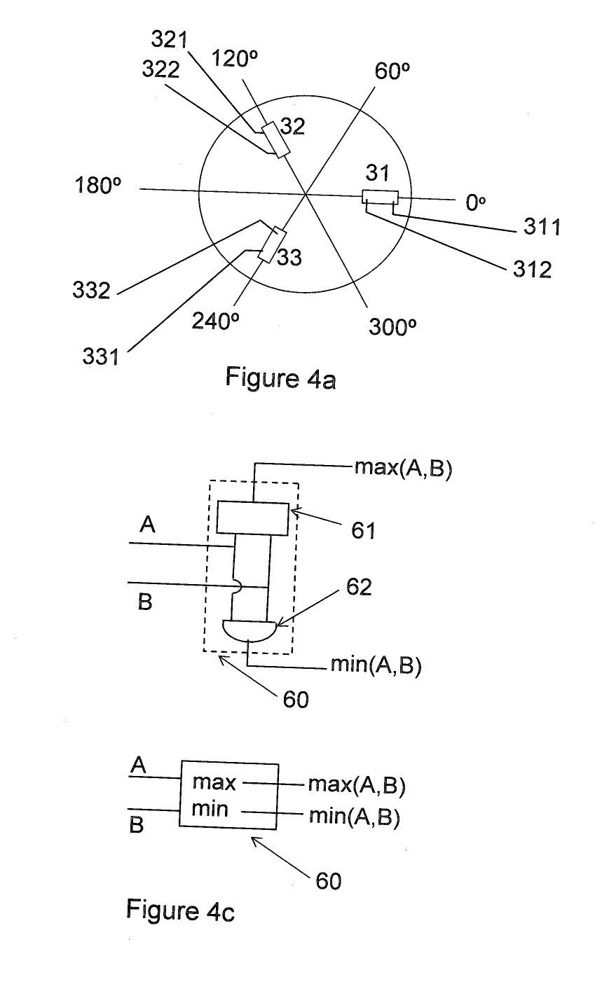

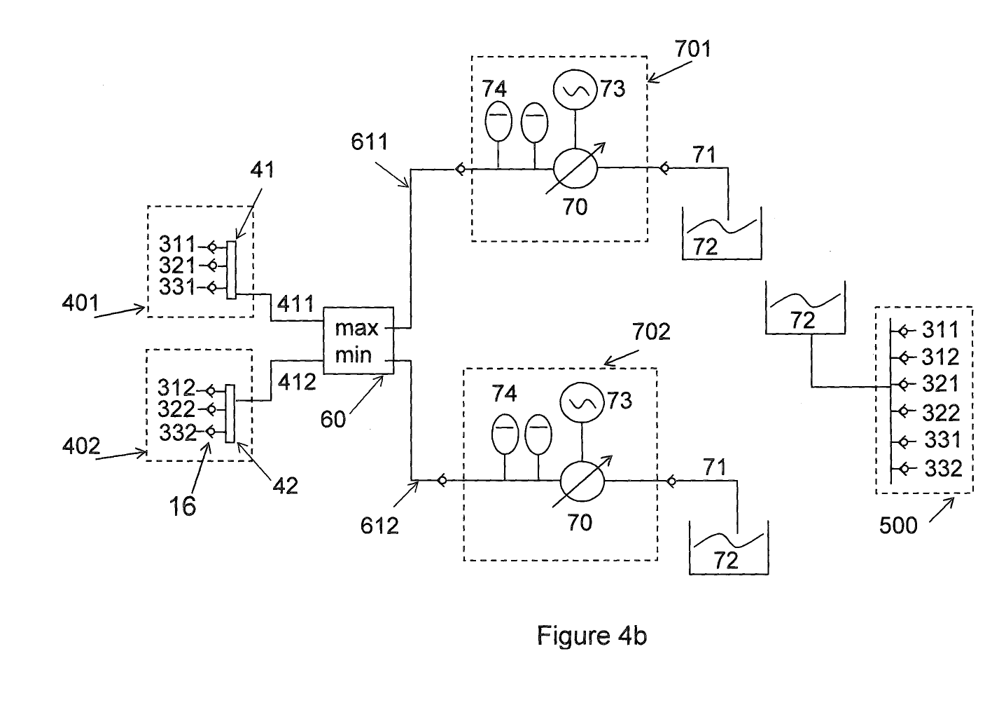

An embodiment with three piston cylinders appears in FIG. 4a. The view is from the z direction looking down with the pole at the center of the circle. The three piston cylinders are (31), (32), (33) placed at 0° degrees, 120° degrees and 240° degrees respectively. Each piston cylinder has two ports. Piston cylinder (31) has ports (311), (312), piston cylinder (32) has ports (321), (322), and piston cylinder (33) has ports (331), (332). The flows from the above ports are connected through conduits to the respective numbers in FIG. 4b, where the hydraulic diagram for this configuration is shown. Flow from ports (311), (321), (331) is connected through check valves (16) to manifold (41) to form the assembly (401), whose out flow is (411). Similarly flow from ports (312), (322), (332) are connected through check valves (16) to manifold (42) to form assembly (402), whose out flow is (412). To understand the operation, assume for the moment that the pole moves in the direction of the 0° meridian. Then port (311) will have outflow and also ports (332) and (322) will have outflow and with equal pressure between them, but smaller than that of (311). The rest of the ports (312), (321), (331) will have inflow from tank (72), through the return assembly (500). This implies that (411) will have as out flow the flow of (311). In assembly (402), (322) and (332) will have equal pressure and therefore, one will not block the other. They will both flow and (412) will have the pressure of (322) (which is equal to (332)) but smaller than (311). Suppose now that the pole moves in the direction of the 180° degrees meridian. Then (312) will have outflow and also (321) and (331) will outflow with equal pressure but less than that of (312). In this case (412) will carry the higher pressure and (411) the smaller pressure. Note that if the pole moves away from the 180° degrees meridian, then (321) will not have equal pressure to (331) and assembly (401) will block the outflow from either (321) or (331) (whichever has less pressure) resulting in the blocking of the pole to move away from the meridian. This applies to all six meridians at 0°, 60°, 120°, 180°, 240°, 300° degrees. The pole is restricted to move along those meridians only, because of the restrictive assemblies (401) and (402). The pressure in (411) is bigger than that in (412) or vice versa depending on the meridian of motion of the pole. To separate high pressure fluid from lower pressure we use a max/min component (60), whose internal structure is explained in FIG. 4c. In the upper schema we see the inner structure of the component (60) that is symbolized by the schema at the lower part of the figure. It consists of an AND gate (62) that allows the min of the pressures A, B to pass and of an OR gate (61) that allows the max of the pressures A, B to pass. In case A=B then both the AND and the OR gate will be open and out of the max/min component we will obtain max(A,B)=min(A,B). Returning to FIG. 4b we direct the max pressure through conduit (611) to power extraction assembly (701) and the min pressure through conduit (612) to power extraction assembly (702). The separate treatment of different pressures increases power extraction and hence component (60) can be regarded as a system for optimization of power extraction. In other configurations, as we will expose below, this system will be more involved. The power extraction assemblies (701), (702), in this embodiment consist of accumulators (74), hydraulic motors (70), generators (73). Low pressure fluid, after its use by the hydraulic motor (70), is concentrated through conduit (71) in tank (72) and forwarded through return assembly (500) back to the corresponding ports of the piston cylinders. Further optimization is also possible by transfer of fluid from assembly (701) to (702) and vice versa by monitoring the operation efficiency of the motors-generators.

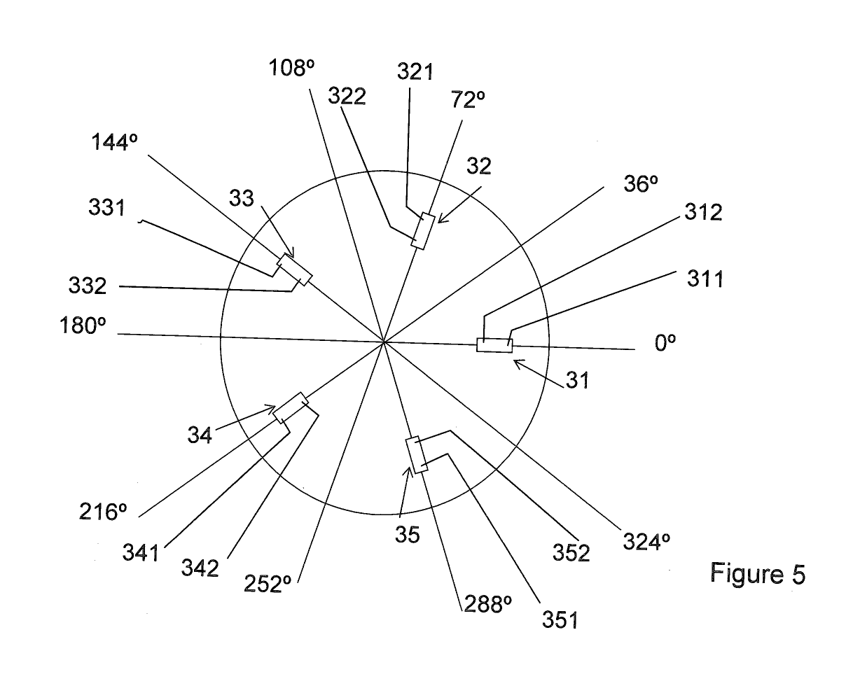

An embodiment with five piston cylinders appears in FIG. 5. The hydraulic circuit in this configuration uses ten manifolds with check valves for the following triads of ports [(311), (331), (341)], [(312), (332), (342)], [(321), (341), (351)], [(322), (342), (352)], [(331), (351), (311)], [(332), (352), (312)], [(341), (321), (311)], [(342), (322), (312)], [(351), (321), (331)], [(352), (322), (332)]. With similar arguments as for the case of three piston cylinders, we see that the pole is restricted to move along the meridians at 0°, 36°, 72°, 108°, 144°, 180°, 216°, 252°, 288°, 324° degrees only. The pressure out of the manifolds comes at three levels and appropriate but more involved optimization assembly of max/min components is needed to direct them for separate treatment by the power extraction assemblies. This embodiment has already very small loss due to misalignment of the direction of waves with one of the allowed meridians of motion. The maximum misalignment is 36°/2=18° degrees=Pi/10 rad. The cos [18°]=cos [Pi/10]=0.9510, which says that we have at maximum 5% loss. But on the average it will be cos [Pi/20]=0.987 which corresponds to 1.3% loss. So there is no need to seek configurations with many more piston cylinders.

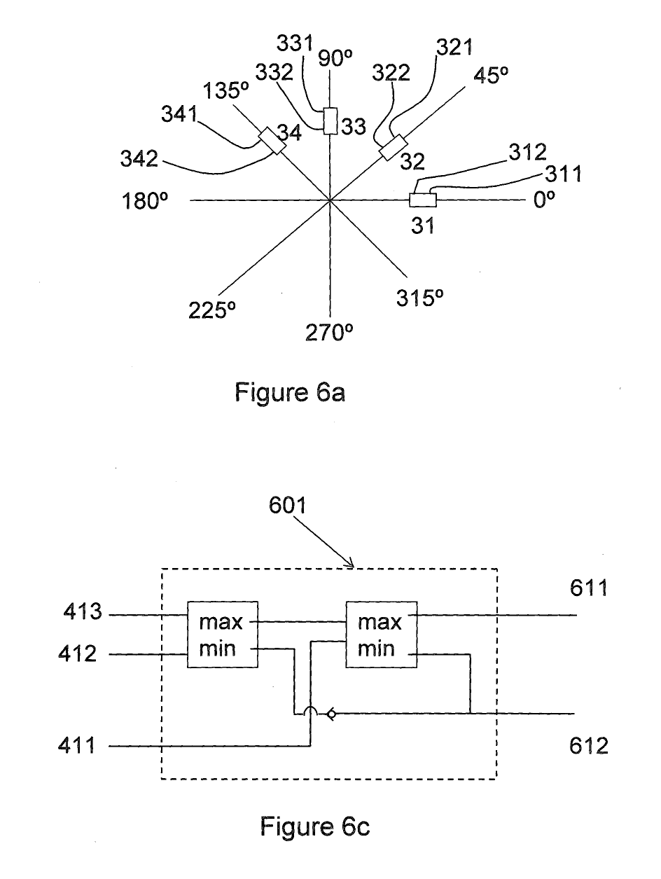

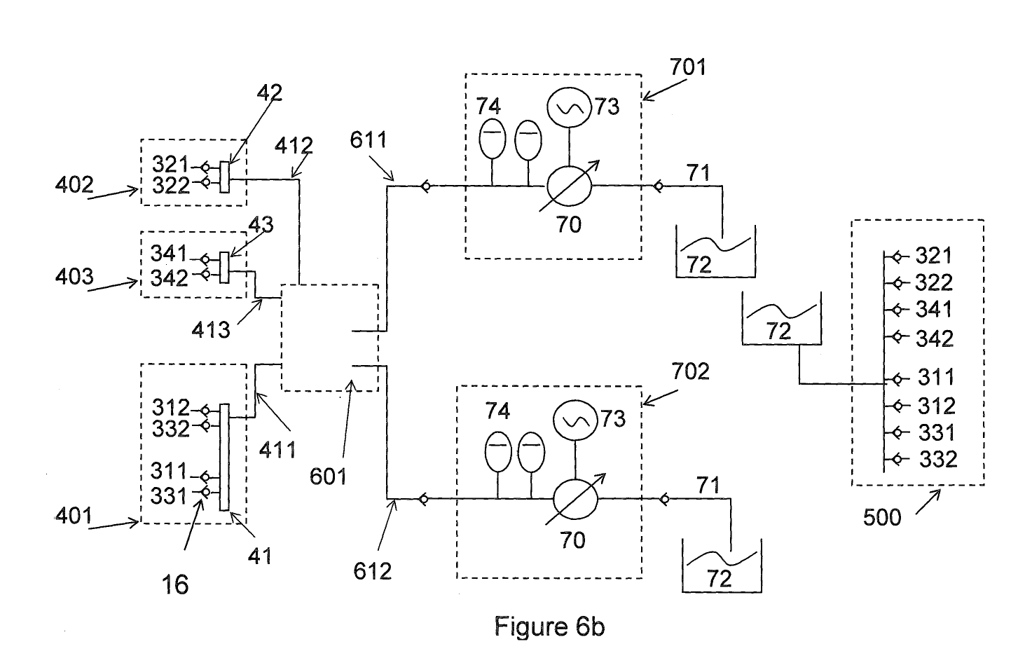

Another embodiment with four piston cylinders appears in FIG. 6a. It consists of two dyads of piston cylinders [(31), (33)] and [(32), (34)]. Each dyad has its piston cylinders in right angles. One dyad is displaced from the other by an angle of 45° degrees. The hydraulic diagram appears in FIG. 6b. Assembly (401) restricts the motion of the pole. In particular, suppose the pole moves along the 45° degrees meridian. In assembly (401), only (331) and (311) will have outflow ((312) and (332) will have inflow from assembly (500)), which will be equal in pressure and hence there will be out flow from (411). Also (321) will have bigger pressure than (331), (311), while (341), (342) will have no flow because piston cylinder (34) is at right angles to piston cylinder (32) (no change in piston arm). The motion of the pole is restricted along the 45° degrees meridian, because any attempt to go away from it makes the pressure of (311) and (331) unequal, which blocks the check valve of either (311) or (331) and stops the motion of the pole pushing it back to the meridian. In case the pole moves along the 0° degrees meridian, we will have outflow from (311), (342), (321). The pressure of (311) will be bigger than that of (342) and (321). The motion of the pole is restricted because piston cylinder (33) and (31) are at right angles and ports (331), (332) and (311) are connected to restriction assembly (401), because of which outflow from (311) prohibits outflow from either (331) or (332), thus restricting motion only along the 0° degrees meridian. In this direction (0° degrees meridian) one may observe that if the pole stops (for example when it reaches the end of the oscillation and is ready to move back again), there is no flow in (311). This may allow (331) or (332) to have outflow and thus the pole may fold at 90° degrees from the 0° direction. This situation though is only theoretical, since almost always there will be pressure in the manifold (41) due to previous operation, which will not allow flow from (331) or (332) when the direction of the waves is in the 0° degrees meridian, while the bias of the pole towards the vertical position will not let it fold. The same observation holds for the 180° degrees meridian.

The case of motion of the pole along the 135° degrees or the 315° degrees meridian is slightly different. Suppose we move along the 135° degrees meridian, then we have flow from (341), which has also the bigger pressure, and flow from (312) and (331), which have lower pressure. However, the length of movement of the piston arm is not equal between (31) and (33) if the pole moves along the 135° meridian, as it can be shown using spherical trigonometry. Since restriction assembly (401) demands that (331) be equal to (312) in pressure, we must have equal piston arm displacement between the for the piston cylinders (31) and (33). Therefore, to have equal pressure, the pole will travel slightly off the 135° degrees meridian. It can be calculated that it will start at 135° degrees but move gradually to approximately 145° degrees as it inclines to horizontal position. This peculiarity for the 135° and 315° degrees meridians, poses no problem because the loss of power is of the order of 1−cos [10°], which is approximately 1.5%. and only for horizontal inclination of the pole. In real life conditions the pole's inclination does not exceed 30° degrees, and this peculiarity is negligible.

As in previous embodiments, the flow from (411) and from the other ports (321), (322), (341), (342) must be treated separately according to the pressure they carry to optimize power extraction. For this purpose and to economize (321) and (322), which cannot both have outflow at the same time, are connected through check valves to a manifold (42) and form assembly (402) with outflow (412). Similarly, (341) and (342) are connected through check valves to another manifold (43) forming assembly (403) with outflow (413). An optimizing assembly (601) is used to separate and direct high and low pressure through conduits (611), (612) respectively, for different treatment to separate power extraction assemblies (701) and (702). The details of construction of the optimizing extraction assembly (601) appear in FIG. 6c,which is easily understood once we realize that there are only three possible situations: (a) (412) has high pressure, (413) zero pressure and (411) low, (b) (412) zero, (413) high, (411) low, (c) (412) and (413) low, (411) high. It is worth noting that for this embodiment the losses due to misalignment of the direction of the motion of the waves with the meridian of motion of the pole is at maximum 45°/2=22.5° degrees=Pi/8 rad. The loss is 1−cos [Pi/8]=1-0.9239=7.6%. But on the average it will be 1−cos [Pi/16]=2%, which is quite satisfactory considering the economy and simplicity of using only four piston cylinders.

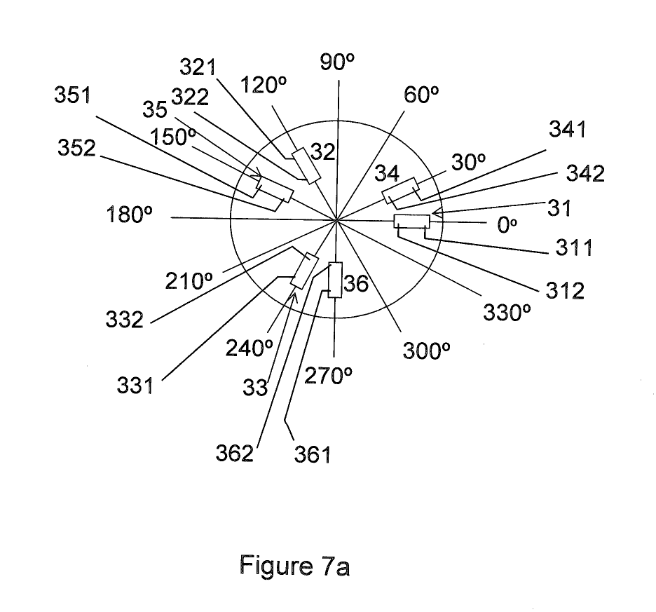

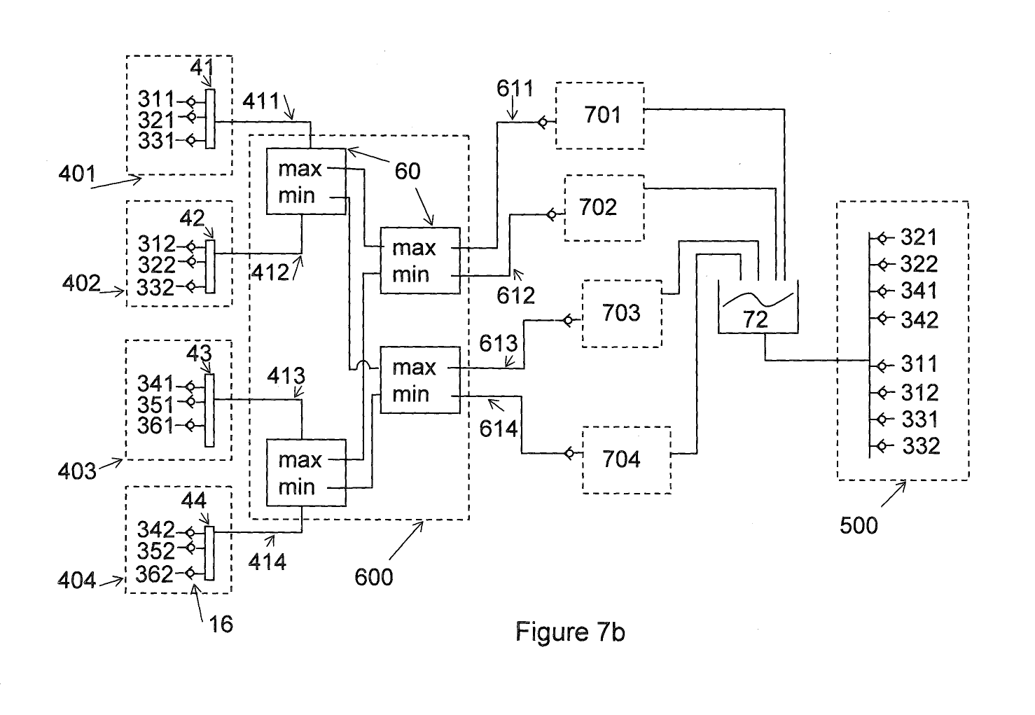

An embodiment with six piston cylinders is shown in FIGS. 7a and 7b. In FIG. 7a the position of piston cylinders is shown. One triad with piston cylinders (31), (32), (33) placed at 120° degrees apart and the second triad similarly for pistons (34), (35), (36). The two triads are displaced by 30° degrees. The restrictive assemblies in this case are four: assembly (401) for ports (311), (321), (331), which are connected through check valves (16) to manifold (41), assembly (402) for ports (312), (322), (332), connected to manifold (42), assembly (403) for ports (341), (351), (361), connected to manifold (43), assembly (404) for ports (342), (352), (362) connected to manifold (44).To understand how the pressures in the manifolds operate consider for example motion of the pole along the meridian of 0° degrees. In (401) there will be flow from (311) only. In (402) there will be equal pressure flow from (322) and (332) only. This restricts motion along the meridian of 0° degrees. In (403), port (361) has zero flow because it is 90° degrees from the direction of 0° degrees and only port (341) has flow. In (404), port (342) has zero flow because it receives flow from the return assembly (500), (362) is zero because it is 90° degrees from the 0° degrees meridian and only port (352) has flow. The pressure at the outflow (411) of assembly (401) will be higher than that in outflows (413), (414) of assemblies (403) and (404) because the piston-cylinders are misaligned by 30° degrees from the direction of motion of the waves. Further, the pressure in the outflow (412) of assembly (402) is smaller than (413), (414), because the piston cylinders (32) and (33) that create flow in (402) are equally misaligned by 120° degrees from the direction of motion of the pole. Still the pressure in (413) and (414) is not equal because one is due to (341) and the other to (352). The change in length of the arms of the piston cylinders (34) and (35) is not the same when one contracts and the other expands as one can show using spherical trigonometry. We already encountered this phenomenon in the four piston cylinder embodiment.

There will be a difference making the one slightly bigger than the other in pressure. Hence, in a six piston cylinder structure we get four levels of pressure. The optimization power extraction assembly (600) consists of four min/max components. When outflows (411), (412) one has high pressure and the other low pressure, (413) and (414) have almost equal middle level pressure and vice versa. The power extraction optimization assembly (600) separates levels of pressure starting with the highest (611) and in decreasing order (612), (613), (614) and leads them to separate power extraction assemblies (701), (702), (703), (704). The pressure difference in (612), (613) is not high and hence (702), (703) maybe reduced to a single assembly. As we already mentioned in other embodiments further optimization is possible by monitoring the operation level and efficiency of each power extraction assembly and transferring fluid from one to the other through controlled interconnections.

It is further understood that when six piston-cylinders are used we have 12 possible meridians of motion 30° degrees apart. Thus, the maximum misalignment of the meridian of motion of the pole from the direction of the motion of the wave is 30°/2=15° degrees. Therefore, the max loss is 1−cos [15°]=1−cos [Pi/12]=3.4%, while the average loss will be 1−cos [Pi/24]=0.9%. Hence. losses from this reason are minimal.

One may construct other embodiments with 7 piston cylinders, or 8 piston cylinders consisting of two independent tetrads, or 10 piston cylinders consisting of two independent pentads or 12 piston cylinders consisting of two independent hexads, etc. But at this point it appears as an unnecessary complexity.

The wave catching structure (9) may take several forms: (a) The fin form has already been shown in FIG. 1 and FIG. 2 and again in FIG. 8b. Apart from the four fin form (92), three or more than four fins are possible forms. (b) The cylinder with axis the axis of the pole. (c) The inverted frustum six sided pyramid (93) (see FIG. 8c). This is appropriate for a three piston cylinder solution, where the pole is restricted to move along six equally spaced meridians. The frustum pyramid must be positioned so that each of each six faces looks one meridian. The frustum pyramid is inverted because for a given volume of material allocated to the wave catching structure it is better to have a wider vertical section on the upper part where the energy of the waves is higher. (The opposite argument holds when the pole is hanging down) (d) The eight-sided pyramid frustum (94) in FIG. 8d is appropriate for a four piston cylinder configuration. In this case each face of the pyramid must look at one of the eight meridians along which the pole is restricted to move. (e) The frustum cone or a truncated ellipse or other appropriate curve by revolution around the pole axis as in (91) see FIG. 8a, for embodiments with more piston cylinders. An alternative form for a wave catching structure is that described in FIG. 9a, 9b, 9c. The structure consists of a rigid cage (95), within which a flexible container or a composition of flexible containers (96) is located. The flexible container is filled or partly filled with fluid (like fresh water and/or air etc.). The pressure of the wave, as it arrives, will deform the flexible container giving it a shape like the one in FIG. 9b, where the side accepting the wave is flattened, while the other assumes the shape of the cage. This deformation makes wave catching more efficient than having a rigid structure and adapts to waves coming from any direction. The flexible container is useful to consist of several compartments like, for example, the one depicted in FIG. 9c. In this form the flexible container is made up of donuts placed one on top of the other following the shape of the cage. By having separate compartments one can control the buoyancy of the structure more closely, keeping the upper containers more buoyant than the lower ones and adjusting the pressure in each one so that the desired deformation is achieved. This ability to adjust, may also be used to adjust to different sea states.

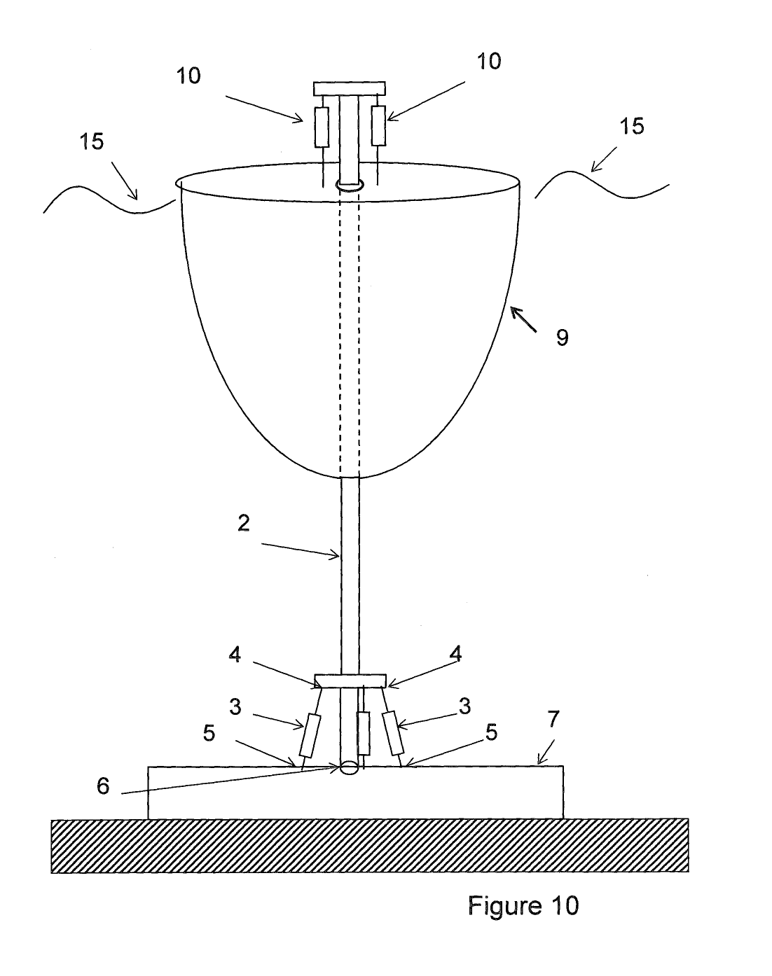

The wave catching structure (9) is not required to be rigidly fixed to the pole. One may notice that if allowed to slide along the pole, it will catch the potential energy of the waves when in vertical position, while when in inclined position, it will catch a combination of the potential and kinetic energy of the waves. We may improve the efficiency of the device by absorbing energy from this motion as well, apart from the energy absorbed by the oscillatory inclination of the pole. Towards this aim we may use piston cylinders (10) (see FIG. 10) to convert the oscillatory motion of the wave catching structure along the pole into fluid oscillation and use it to extract energy by the same or a separate set of power extraction devices as previously described. In FIG. 10 an embodiment is presented that is fixed to the bottom of the sea. The sea surface (15) almost covers the wave catching structure (9). The pole is able to incline according to the number of piston cylinders (3) and the corresponding allowed meridians absorbing energy through the same piston cylinders (3), while the wave catching structure (9) is allowed to slide along the pole absorbing extra energy through piston cylinders (10).

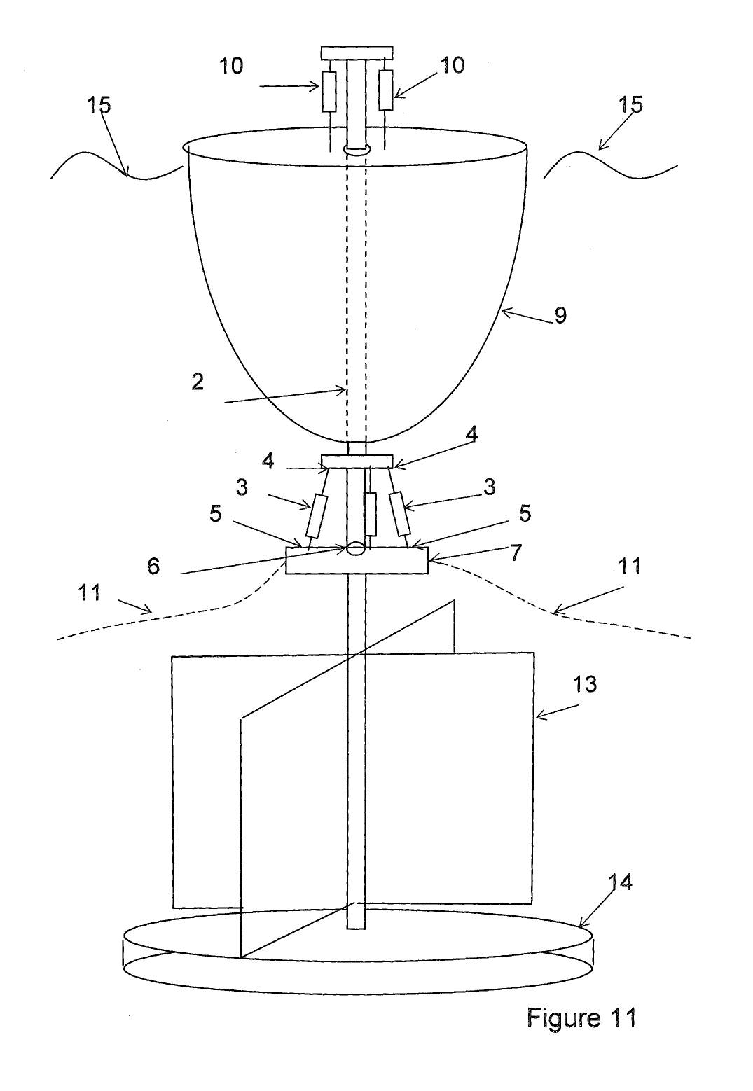

A floating embodiment is shown in FIG. 11. The device is the same as that shown in FIG. 10. The only difference is that below the base (7) a leg (12) extends downward. The leg carries means to resist horizontal motion like the fins (13) and means to resist vertical motion like the disk (14). The leg must be deep enough to take advantage of the fact that wave energy diminishes exponentially with distance from the surface and hence at distance greater than half a wave length such energy is very close to zero. The whole device is moored by lines (11). The buoyancy of the pole (2) may be independently adjusted either by partially flooding its inside or/and adding a float to the pole—for example at the base (7).

The device is simple to construct and deploy. The base (7) or/and the disk (14) or/and the wave catching structure (9) can be filled with air forcing the device to float horizontally. In this position it can be towed from and to a harbor for deployment or maintenance.

In extreme weather conditions the device may be allowed to flex freely on the universal joint (6) by short circuiting the piston cylinders (3) thus easing the stresses. In parallel one may decrease buoyancy of the wave catching structure to keep the pole inclined. If it is floating, its buoyancy may be reduced, thus letting it sink deeper to avoid the harshness of the conditions at the surface.

1. Apparatus for extracting energy from waves comprising:
A pole (2) with one end attached to a base (7) by a universal joint or ball joint (6).
A wave catching structure (9) attached to the other end of said pole.
Elements to extract energy (3), (70), (73), (74), (701), (702), (703), (704) from the relative motion of the pole with respect to the base.
A system (3), (401), (402), (403), (404) to restrict to certain directions the motion of the pole (2) with respect to the base (7).

2. Apparatus according to claim 1, further comprising an adjustable bias system to keep the pole in parallel to the gravity field, either by adjusting the weight or adjusting the buoyancy characteristics of the parts of the device or using any other means to make the self frequency of the oscillation of the pole close to the wave frequency.

3. Apparatus according to claim 1 or 2, wherein piston cylinders (3), (31), (32), (33), (34), (35), which are activated by the motion of the pole (2) are used to pump fluid as part of the said elements to extract energy.

4. Apparatus according to claim 3, wherein the said system (3), (401), (402), (403), (404) that restricts the motion of the pole (2), consists of an assembly of piston cylinders (3), (31), (32), (33), (34), (35), check valves and/or manifolds and/or of other hydraulic or electro-hydraulic components, sensors and/or computers.

5. Apparatus according to claim 3 or 4, wherein the said elements to extract energy include hydraulic motors (70), accumulators (74), generators (73), devices for storing rotational energy (like flywheels).

6. Apparatus according to claim 3 or 4, wherein the said energy extracting elements include water turbines (70) coupled to generators (73).

7. Apparatus according to claims 3 to 6, wherein a system to optimize and increase efficiency of power absorption and extraction is included, consisting of an assembly (60), (600), (601) of hydraulic components and/or computers.

8. Apparatus according to claims 3 to 7, wherein the number of piston cylinders (3) are 2, or 3, or 4, or 5, or 6 or 7, or 8, or 10, or 12.

9. Apparatus according to claims 1 to 8, wherein the said wave catching structure (9) consists of one of the following alternative forms: (a) Three or four or more fins (92) parallel to the pole axis, (b) cylinder, (c) frustum pyramid (93), (94), (d) frustum cone, (e) Any solid (91) formed by revolution of a curve around the pole axis.

10. Apparatus according to claims 1 to 8, wherein the said wave catching structure (9) consists of a rigid cage (95), within which one or more flexible containers (96) filled or partially filled with fluid are located.

11. Apparatus according to claim 9 or 10, wherein the said wave catching structure (9) is free to slide along the pole and is attached to it through piston cylinders (10) to absorb and subsequently extract extra energy.

12. Apparatus according to any preceding claim, wherein the device is floating, moored and includes a long leg below the base, extending downwards. Said leg having parallel (13) and vertical (14) to the gravity fins and elements, to resist horizontal and vertical motion.

13. Apparatus according to any preceding claim, wherein the device is protected from extreme weather conditions either by letting the pole (2) oscillate freely or/and changing the buoyancy of the wave catching structure (9) or/and the other elements of the structure or/and letting it sink deeper if it is in floating form.

14. A method of extracting power from waves comprising the steps of:
(a) deploying an apparatus (1) according to any of the preceding claims
(b) attaching the apparatus (1) either to the sea bed or mooring it if the device is in floating form.
(c) optimizing the power absorption and power extraction characteristics.
